(19) United States
(12) Patent Application Publication
(10) Pub. No.: US 2020/0404886 A1
(43) Pub. Date: Dec. 31, 2020

(54) Animal Behavior Management System

(71) Applicant: Andy H. Gibbs, Tucson, AZ (US)

(72) Inventor: Andy H. Gibbs, Tucson, AZ (US)

(21) Appl. No.: 16/917,011

(22) Filed: Jun. 30, 2020

Related U.S. Application Data
(60) Provisional application No. 62/868,941, filed on Jun. 30, 2019.

(51) Int. Cl. A01K 15/02; A01K 27/00

(52) U.S. Cl. CPC A01K 15/021; A01K 29/005; A01K 27/009

(57) ABSTRACT

An animal behavior management system for managing animal behaviors and monitoring hearing acuity of an animal. The animal behavior management system generally includes a connecting device adapted to be attached to an animal, a monitoring device configured to monitor an action of the animal, a control unit configured to determine if the action of the animal is related to an undesirable behavior of the animal and a sound device in communication with the control unit. The sound device is adapted to emit a plurality of sounds that are audible to the animal. The control unit activates the sound device to produce one of the plurality of sounds when the action is determined by the control unit to be an undesirable behavior.

I hereby claim benefit under Title 35, United States Code, Section 119(e) of United States provisional patent application Ser. No. 62/868,941 filed Jun. 30, 2019. The 62/868,941 application is currently pending. The 62/868,941 application is hereby incorporated by reference into this application.

### STATEMENT REGARDING FEDERALLY SPONSORED RESEARCH OR DEVELOPMENT

Not applicable to this application.

### BACKGROUND

### Field

The various embodiments are directed to an animal behavior management system and method to manage animal behaviors and monitoring hearing acuity of an animal.

### Related Art

Any discussion of the related art throughout the specification should in no way be considered as an admission that such related art is widely known or forms part of common general knowledge in the field.

Domesticated dogs and other animals often experience idiopathic or environmentally induced. For example, a pet dog may become anxious when the human caretakers leave the dog alone in the house. Anxiety is effectuated in various forms of discouraged behavior, such as barking or howling. Further, like humans, a dog's hearing acuity declines with age, yet a dog's hearing loss is rarely recognized by the pet owner. Hearing loss may result in the owner's perceived change in the dog's behavior although the cause of the behavioral change may be attributable to the dog's inability to hear the owner's commands.

### SUMMARY

The present invention is a novel device and method of introducing sound to distract the dog by breaking the anxiety pattern, thereby resulting in a change in behavior from a discouraged behavior to a behavior preferred by the owner. Further, the method provides for monitoring hearing loss trends over time.

There has thus been outlined, rather broadly, some of the embodiments of the animal behavior management system in order that the detailed description thereof may be better understood, and in order that the present contribution to the art may be better appreciated. There are additional embodiments of the animal behavior management system that will be described hereinafter and that will form the subject matter of the claims appended hereto. In this respect, before explaining at least one embodiment of the animal behavior management system in detail, it is to be understood that the animal behavior management system is not limited in its application to the details of construction or to the arrangements of the components set forth in the following description or illustrated in the drawings. The animal behavior management system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exemplary diagram illustrating a behavior modification feedback system comprising a motion sensing dog collar and sound-producing device on a network in accordance with an embodiment thereof.

FIG. 2 is an exemplary diagram illustrating a variation of behavior modification feedback system comprising a motion sensing dog collar and sound-producing device on a network.

FIG. 3 is an exemplary diagram illustrating another variation of behavior modification feedback system comprising a motion sensing dog collar and sound-producing device on a network.

FIG. 4 is an exemplary diagram illustrating a table of noise types that may be played through a sound producing device.

FIG. 5 is an exemplary illustration of a process schematic diagram showing the selection of a sound in response to a dog behavior.

FIG. 6 is an exemplary illustration of a flow chart showing one process of setting up a sound device.

FIG. 7A is an exemplary illustration of one method of cycling through a plurality of sounds to be played on a sound device.

FIG. 7B is an exemplary illustration of one variation of a method of cycling through a plurality of sounds to be played on a sound device.

FIG. 8 is an exemplary illustration of a graph showing a typical dog's hearing range.

FIG. 9 is an exemplary illustration of a graph showing a given dog's loss of hearing by comparing an historical behavioral response to frequencies and amplitudes to a current behavioral response to frequencies and amplitudes.

### DETAILED DESCRIPTION

Various aspects of specific embodiments are disclosed in the following description and related drawings. Alternate embodiments may be devised without departing from the spirit or the scope of the present disclosure. Additionally, well known elements of exemplary embodiments will not be described in detail or will be omitted so as not to obscure relevant details. Further, to facilitate an understanding of the description, a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments” is not exhaustive and does not require that all embodiments include the discussed feature, advantage or mode of operation.

The word “sound” as used herein means a sound vibration, preferably of a frequency between 65 Hertz (Hz) and 60 Kilohertz (kHz) that would be audibly recognizable by a dog. The “sound” may be of any volume amplitude at any given frequency, and may comprise a single or a plurality of sounds played continuously for any duration of time, or may be played intermittently. Further, the sound may comprise recordings of a human voice of any length duration, a digitally generated tone at one or more frequencies played sequentially or concurrently, or any combination of recorded human sounds or digital tones. Exemplary sounds are described below, but they are provided to illustrate the methods of creating and playing sounds, and are not meant to be limiting.

The word “noise” is used herein to describe a sound of a specific spectral density (a noise with specific static or varying amplitudes or intensities) throughout the audible frequency range. White noise, Pink noise, Brownian noise and other types of noises are well known to those skilled in the art. It is also well known that humans respond positively to certain of these noises. These noises are well known to mask or drown out unwanted or nuisance noises, and create a sense of calmness in humans. Although these noises were defined with respect to the human audible frequency range of 20 Hz to 20 kHz, they are referenced throughout this specification as they would analogously pertain to the canine audible frequency range of 65 Hz to 60 kHz.

While the various embodiments disclosed herein illustrate usage of the animal behavior management system with a dog, it can be appreciated the various embodiment of the animal behavior management system may be used with other animals (e.g. cats, horses). The animal may or may not be domesticated animal.

In one exemplary embodiment, data from a motion sensing dog collar is communicated to a unique database containing the dog's historical movement data. The movement data is analyzed against movement data that corresponds to known behaviors of the dog as recorded in the dog's individual profile. If the movement data corresponds to a discouraged behavior, artificial intelligence instructions will cause a sound to be played on a sound device proximate to the dog as a means of causing a modification of the undesired behavior. Movement data is received during and after the sound is played, and re-analyzed to determine if the sound caused a modification of the undesired behavior to a desired behavior. If the desired behavior was achieved, the selected sound is then recorded in the pet's profile, and the sound is therefore associated with the undesirable behavior. Upon the database recognizing future occurrences of the undesired behavior, artificial intelligence will initiate reactivation of the sound on the sound device, and continue the sound until the desired behavior data signature from the dog's collar is received and recognized.

In one exemplary embodiment, upon recognizing collar data associated with an undesired behavior, and when a sound associated with ameliorating the undesired behavior has been previously recorded in the dog's individual profile, the sound is caused to be played again on the sound device proximate to the dog. If the instance of playing the sound previously associated with ameliorating the undesired behavior does not cause a repeated desirable behavior, a series of a plurality of different sounds will be played upon the sound device until the collar data indicates that the desired behavior has resulted. The new sound associated with the desired resulting behavior will be recorded in the dog's individual profile to be played at a future occurrence of the undesired behavior.

It should be noted that many dog behaviors may be detected by means of wireless devices including for instance to microphones that detect the occurrence of unwanted barking, or smart collars that detect when a dog is scratching. More specifically, a system comprising data acquisition devices including wearable smart collars, wireless food and water bowls, microphones, and motion activated cameras communicate data related to a pet's daily activities to a database containing a continually appended record unique to that pet. Further, a second database provides for a library of unique data streams that have been previously determined to occur during a given activity. For instance, the one or more accelerometers incorporated into a wireless activity collar will provide a unique data stream, or data signature that correlates to a dog scratching, and will provide a unique and completely different data stream that correlates to a dog aggressively shaking its head as if it is shaking a toy, as well as identifying when a dog is running, walking or jumping. The list of behaviors that can be determined by means of the different data signatures from a dog's sensor-equipped collar can number in the dozens.

Further, smart water and food bowls, alone, together or in combination with other wireless sensors such as a smart collar as just described provide even more information related to each unique pet's daily behavior. For instance, smart food and water bowls communicate data related to the pet's daily drinking and eating routine to a database containing a continually appended record unique to that pet, the routine including the time, frequency and volume of food and water consumed during a predefined period, for instance, each 24 hours.

In the routine of a pet's daily movements, food and water consumption, and vocal activity when the pet's owners are present may appear normal to the pet's owners. However, when the owners are not present, the pet may exhibit unwanted behaviors. Without detection and reporting of the unwanted behaviors to the owners, the unwanted behavior may continue unabated.

As a first example case, a dog may appear to its owners to be normally happy and relaxed when the owners are at home. The collar sensor data will reinforce that the dog is sleeping, or walking through the house as they follow its owners around. However, each weekday morning when the owners leave the house to go to work, the collar sensor data received by the database each morning at about the same time that the owners leave for work indicates that the dog is anxiously running throughout the house. At the same time, a microphone in communication with the database received data indicating that the dog starts to howl and bark at about the same time that the running starts. The occurrence of the collar and microphone data received during the work week, but not during the weekend days when the owners are home, provide a data pattern unique to that dog. Now, a computer analysis of the unique data pattern against a library of many data signatures correlating to many behaviors identifies the pattern of this example case as separation anxiety which is exhibited immediately following the owners leaving the house for work. Anxiety in pets, as in humans, is systemically unhealthy and therefore undesired, notwithstanding that the pet owners don't want their pets to be emotionally stressed. In the case just described, the system described herein provides for the playing of one or more sounds at the time the unwanted behavior is detected. The sounds may be tones that distract the pet, noise that emulates the owners' hustle and bustle through the house when they are present, or messages prerecorded by the owners in the owners' voice meant to calm the pet even though the owners may not be present. The database, having identified the occurrence of the unwanted behavior, and the initiation of the playing of the sounds through a speaker in the home, will further receive data from the smart collar and/or microphone that indicates that the dog's anxiety has diminished as a result of playing the sounds, the database thereafter sending instructions to the smart speaker to cease playing the sound. In this first example case, the system detected the onset of an unwanted behavior, initiated the playing of a sound to ameliorate the unwanted behavior, further detected the substantially reduced or eliminated unwanted behavior and instructed the speaker to stop playing the sound.

In a second example case, the daily eating routine of a dog is recorded in the dog's unique record maintained on a computer database. Data related to the daily eating routine may include the time of day that the owners typically feed the dog and the duration of the eating activity. At the same time, the smart collar data signature will correlate to a head-down, chewing and swallowing behavior that's expected when a dog eats. The predictively repeatable daily pattern of the data signatures just described would be considered by the pet's owners to be normal and acceptable behaviors. On one hand, the time of day that the dog exhibits the eating and chewing behavior are therefore known to the pet owners, as well as the database containing the pet's historical records. On the other hand, the occurrence of the behavior just described, if occurring at a time other than meal time, and more specifically when the data from the wireless food bowl indicates that there is no food in the bowl, combined with the data signature indicating that the dog is shaking its head, can be determined to be chewing and eating something in the house other than the dog's food, or in other words, an unwanted behavior. Pica, typically a psychological disorder characterized by the compulsive ingestion of non-food items is well known in the veterinary community. In practical terms, a dog is exhibiting pica when they destructively chew apart a pillow, or gnaw as the wooden dining room table leg. Therefore, it is important to detect when the dog is eating even there is no food available to eat. In the case just described, the system herein provides for the playing of one or more sounds at the time that pica is detected. The sounds may be tones that distract the pet or messages such as a prerecorded “stop chewing” by the owners in the owners' voice meant to stop the pet from continuing the destructive behavior. The database, having identified the occurrence of the unwanted behavior, and initiated the playing of the sounds through a speaker in the home, will further receive data from the smart collar and/or food bowl that indicates that the dog has stopped the destructive chewing and sends instructions to the smart speaker to cease playing the sound. In this second example case, the system detected the onset of an unwanted pica, initiated the playing of a sound to ameliorate the unwanted behavior, further detected the substantially reduced or eliminated unwanted behavior and instructed the speaker to stop playing the sound.

The two case examples just described are not meant to be limiting, but illustrate the important function of acquiring and analyzing data from one or more devices in communication with a database and which are associated with a unique pet, comparing the data to the pet's historical record and as well against a library of data signatures that correlate to known pet behaviors, determining whether the behavior is unwanted, and activating a sound proximate to the pet as a means of ameliorating the unwanted behavior.

Those skilled in the art will appreciate that there are many unwanted behaviors exhibited by pets. In addition to the separation anxiety and pica as just described, unwanted behaviors, detectable by means of computed analysis of data received from one or more wireless devices associated with a pet may include aggressive behavior (i.e.: lowered head and growling), jumping (i.e.: on people, the kitchen counter or other object) or an extensive list of obsessive-compulsive disorders including but not limited to tail chasing, digging, or biting their food or water bowl.

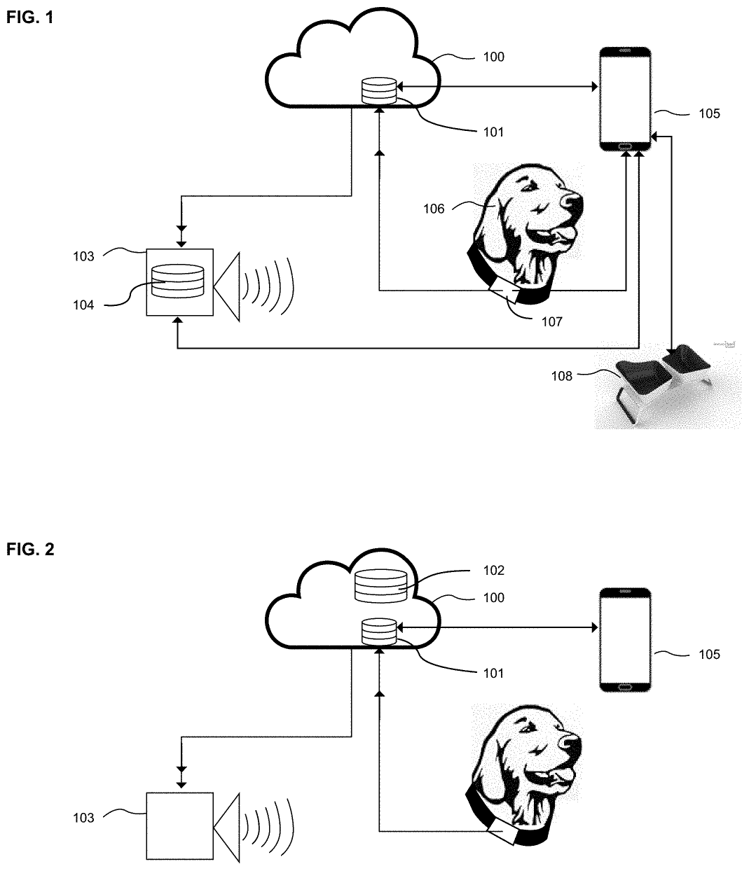

FIG. 1 is an exemplary diagram illustrating a behavior modification feedback system comprising a motion sensing dog collar 107 and sound producing device 103 on a network. More specifically, a motion sensing collar is affixed to a dog 106. In one embodiment, the motion sensing collar includes a motion sensor attached to a collar that is removably attachable about the neck of an animal. Upon sensing motion by means of signals produced by one or more accelerometers or magnetometers, MEMs devices well known to those skilled in the art, a data stream associated with the movement is sent to the dog's database 101 of current and historical movements via Bluetooth communication with a software application on a smartphone 105 or other wireless device, the dog's database preferably being a partition of a cloud database 100. Alternatively, the dog's collar may send the movement data to its unique database on the cloud by means of a WiFi connection.

A sound device 103 comprising at least a signal receiver to receive data from the cloud database containing the dog's database, a power source, and a speaker is data linked to the dog's individual database by wireless or wired means. The sound device may optionally provide for a library of sounds 104 database, the sounds being either digitally recorded into the memory contained on the sound device, or downloaded into the sound device memory from the cloud database. All of the sounds are preferably within a frequency range of 65 Hz to 60 kHz, and of an amplitude that would be audibly recognizable by a dog.

The dog collar and sound device just described are commonly referred to as smart devices in networked communication via the Internet, or Internet of Things (IoT) devices. As can be seen in the drawing, the IoT devices related to a particular dog household may include a smart water and food bowl 108. All of the IoT devices may communicate with the dog's database partition of a cloud database through a smartphone application, or via a WiFi router in direct or indirect communication with the IoT devices.

In practice, when an intelligent machine, namely machine learning and artificial intelligence, applied to data in the dog's collar movement data stored in the dog's profile 101, discovers a data signature indicating an undesirable behavior of the dog, it triggers the actuation of a sound on a sound device 103 proximate to the dog, and subsequently polls the dog collar data correlating to the just-made sound. If the new collar data represents a desirable behavior, the sound is terminated. If the new collar data indicates no change in the undesirable behavior, a different sound is played by the sound device, with a subsequent collar data poll to determine whether the different sound results in a preferred behavior. This process just described continues until a sound, or a combination of sounds modifies the specific undesired behavior to a desired behavior. Thereafter, when the sound to preferred behavior correlation is determined by the intelligent machine, the data signature associated with the undesired behavior is linked to the preferred sound and recorded in the dog's unique profile. Upon a subsequent identification of another occurrence of the undesired behavior, the intelligent machine will autonomously reinitiate the sound sequence to ameliorate the undesired behavior.

As will be immediately appreciated, the number of sounds, combination of sounds, sounds of different frequencies and amplitudes within the hearing range of a dog are nearly limitless. The application of intelligent machine computing to rapidly create a sound and determine responsive dog behavior, and the machine learning that continually improves the duration, amplitude and frequencies of the specific sounds that best ameliorate the undesired behavior in dogs is the preferred method of determining the most effective sound variations out of a nearly limitless number of variations that achieve the desired result.

FIG. 2 is an exemplary diagram illustrating a variation of behavior modification feedback system comprising a motion sensing dog collar and sound-producing device on a network. The sound device 103 is not limited to playing pre-recorded sounds from a local memory, but may play sounds streamed live from the sound database 102 via the internet.

Further, the sound device may play one or more sounds generated by a generator circuit not shown, but integral to the sound device, the switch to generate and play the sound being digital instructions sent from the dog's database partition 101 and/or from the cloud database 100.

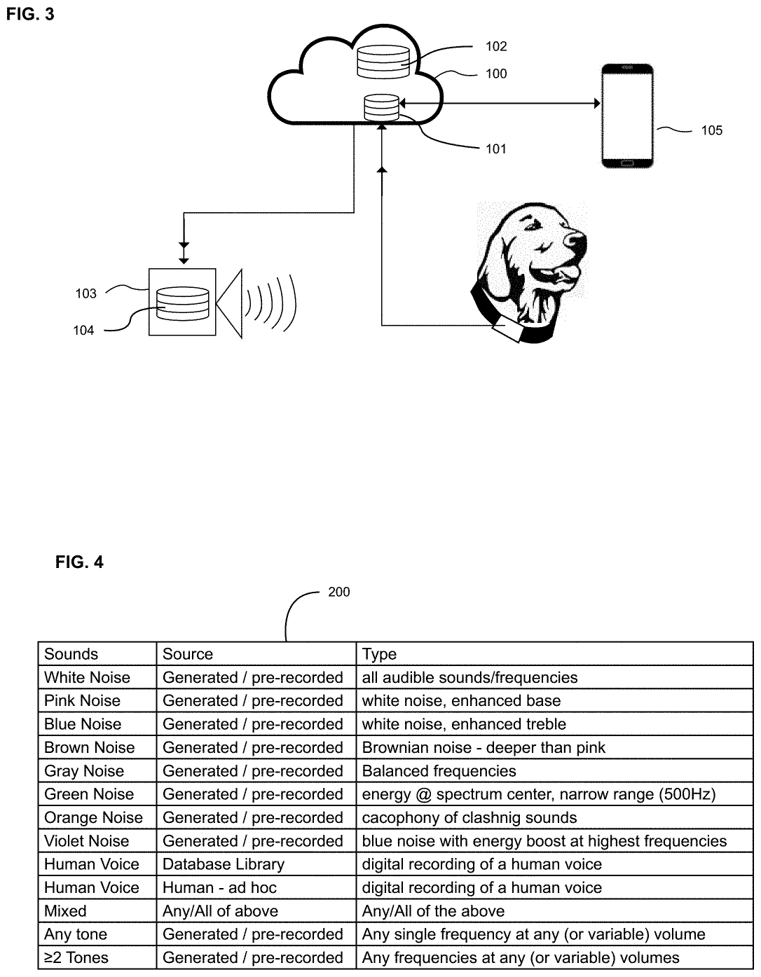

FIG. 3 is an exemplary diagram illustrating another variation of behavior modification feedback system comprising a motion sensing dog collar and sound-producing device on a network. A smartphone 105 is in wireless communication with a unique dog's profile 101 partition of a cloud database 100.

The dog's profile 101 may store one or more sounds associated with that dog's behaviors, the sounds comprising human voice recordings made by the dog's owner through the smartphone app, and/or sounds from the sound database 102 that were played through the sound device, and which produced a desirable behavior change.

The cloud sound database 102 contains a library of pre-recorded sounds of varying tones, frequencies and amplitudes, and algorithms that direct the creation of various sounds by a sound machine 103 sound generator.

Further, a sound machine 103 may provide for local memory storage of a sound library 104 of preferred sounds, the sounds being selected by and downloaded from the cloud database 100 and/or the dog profile database 101, and may additionally store recorded human voice sounds communicated via a software application on the smartphone 105.

FIG. 4 is an exemplary diagram illustrating a table of noise types in a noise library 200 that may be played through a sound device. Colored noises as shown, for instance white noise, pink noise, and others, are well known references to sounds within the human hearing range. However, the colored noises in the diagram, and the characteristics of the colored noises are sounds within the canine hearing range.

As can be seen in the various rows of the diagram, a sound may be a colored sound, a single tone, a plurality of tones, a pre-recorded human voice, or a combination of one or more of the sounds, the sounds being of any preferred frequency and amplitude, and which may be played through the sound device previously described for any duration of time.

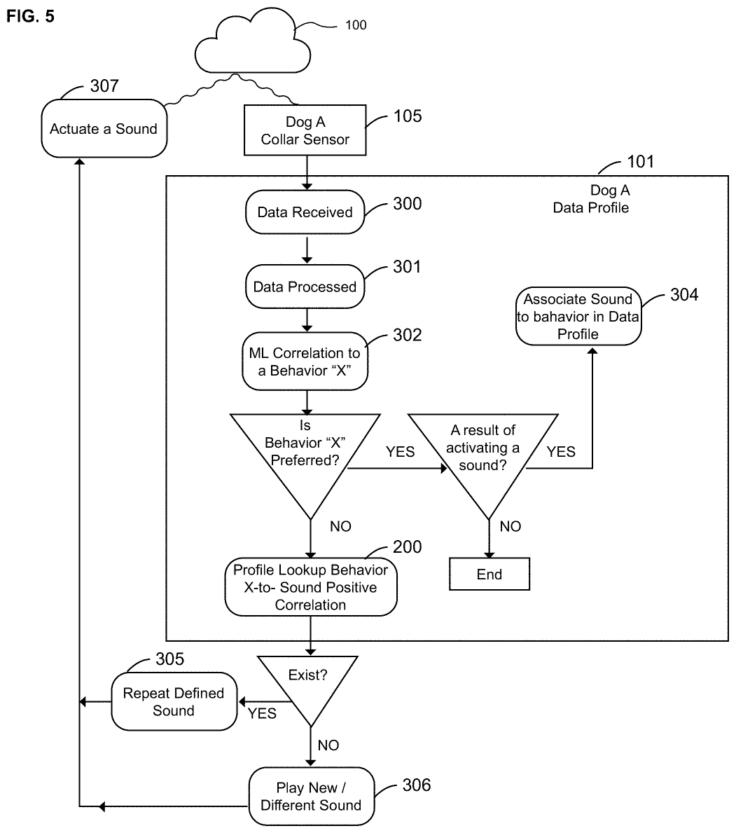

FIG. 5 is an exemplary illustration of a process schematic diagram showing the selection of a sound in response to a dog behavior. More specifically, a motion sensing dog collar 105 senses a movement, and transmits the movement data where it is received 300 in the dog's unique profile database in the cloud as previously described. The collar data is processed 301 and is analyzed using machine learning (ML) that correlates the received collar data to various learned dog behaviors. ML then determines whether the behavior is desirable, or undesirable by a dog owner.

If the behavior is indicated as undesirable, ML performs a lookup 200 to identify any sounds that are learned to have ameliorated the undesirable behavior, and if such sound exists, artificial intelligence (Al) instructs 305 the sound 307 to be played on a sound device proximate to the dog exhibiting the undesirable behavior.

The cloud 100, and more specifically the dog's unique profile database, being informed that a sound has been played with the objective of ameliorating the undesired behavior, receives new collar movement data to determine whether the sound played has, in fact, ameliorated the undesired behavior.

If the sound has not ameliorated the undesired behavior, Al directs the actuation of a different sound 306, and conducts an efficacy analysis. This process is repeated until a sound is identified that positively correlates to a change to the desired behavior.

If the desired behavior is determined by ML, then Al determines whether the behavioral change was attributable to a sound, and if so, adds the sound to the dog's profile 304.

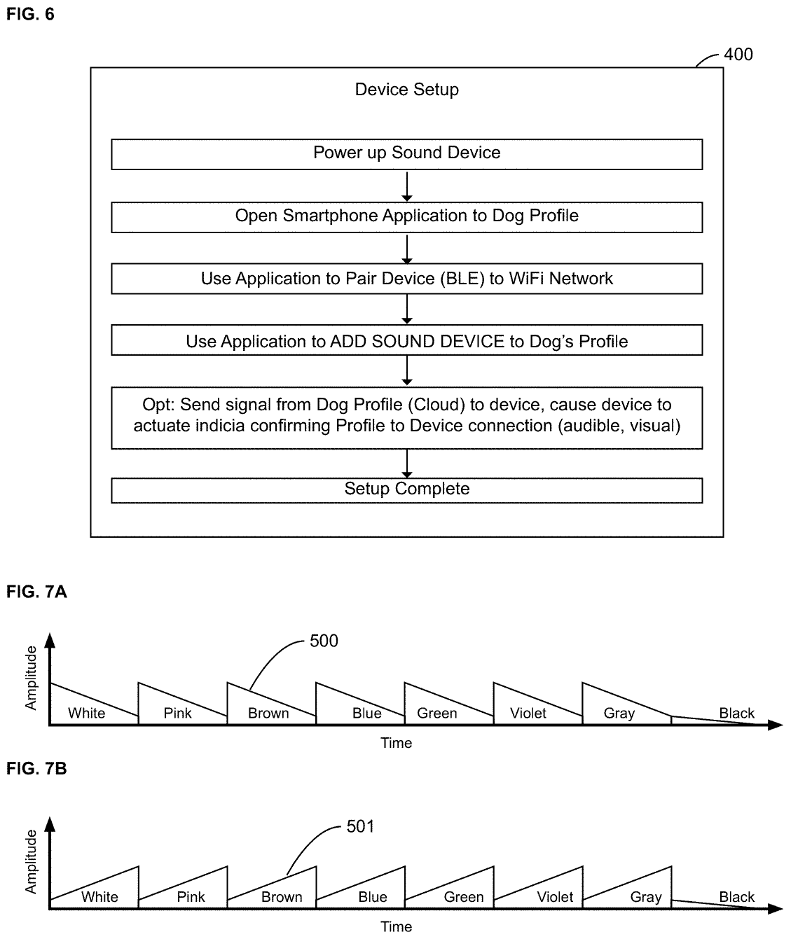

FIG. 6 is an exemplary illustration of a flow chart showing one process of setting up a sound device. More specifically, as a means of setting up an IoT connected sound device, in practice, a user connects the sound device to a power source. The user then opens the corresponding software application on a smartphone of similar Bluetooth enables device. Within the list of Bluetooth identified Bluetooth devices, the user selects the sound device, thereby pairing the sound device to the local WiFi network, and via the software application, connects the sound device to the recognized network of devices within the dog's unique profile as previously discussed. Optionally, the cloud, and more specifically the dog's unique profile database may initiate the sending of a test signal via the internet and local WiFi network to the sound device, causing activation of one or more visual or audible indicia to indicate a successful pairing. The setup process is thereby completed, and the sound device is prepared to receive sound data from the cloud, or is ready to receive communication from the cloud that would initiate the creation and/or playing of a sound upon the sound device.

FIG. 7A is an exemplary illustration of one method of cycling through a plurality of sounds to be played on a sound device. As previously described, the number of possible sound options is practically limitless. The hearing acuity of every dog is assumed to be different. Further, anticipating the dog's behavioral change in response to any given sound it practically impossible. Therefore, playing a broad range of sounds while monitoring the dog for a preferred behavioral change is a method of matching a sound with a behavior.

In the drawing, various sound types are shown on the X axis of the graph, the sounds being played in a sequence over a given time period. The start of each sound is shown with a higher Y axis amplitude with the amplitude declining 500 for each sound until the next sound in sequenced. Preferably, the amplitude would begin in the 50 decibel (dB) range and decline to the 0 to −5 dB level for the frequencies <100 Hz, and >20 kHz, the extreme opposite ends of the dog's hearing range, with a lower dB amplitude in the mid frequency range. As can be readily understood, the object of the method just described is to cycle through an exceedingly large number of frequency, amplitude and types of noise while monitoring the dog's behavior through collar movement data as a means of correlating a positive behavior change to a specific frequency, amplitude and type of noise. Cycling through the noises in a “high to low” pattern is one method.

FIG. 7B is an exemplary illustration of one variation of a method of cycling through a plurality of sounds to be played on a sound device. In the drawing, various sound types are shown on the X axis of the graph, the sounds being played in a sequence over a given time period. The start of each sound is shown with a higher Y axis amplitude with the amplitude ascending 501 for each sound until the next sound in sequenced. Cycling through the noises in a “low to high” pattern is one method.

It should be noted that the methods just described in FIGS. 7A and B are not meant to be limiting, and any sequence or combinations of noise may be used, varying any frequency range of amplitude, and substituting any noise shown in the graphs with any other noise that would reasonably present a virtually unlimited number of noises to the dog would produce the same effect of identifying a specific noise or plurality of noises that would cause the dog to positively change behavior.

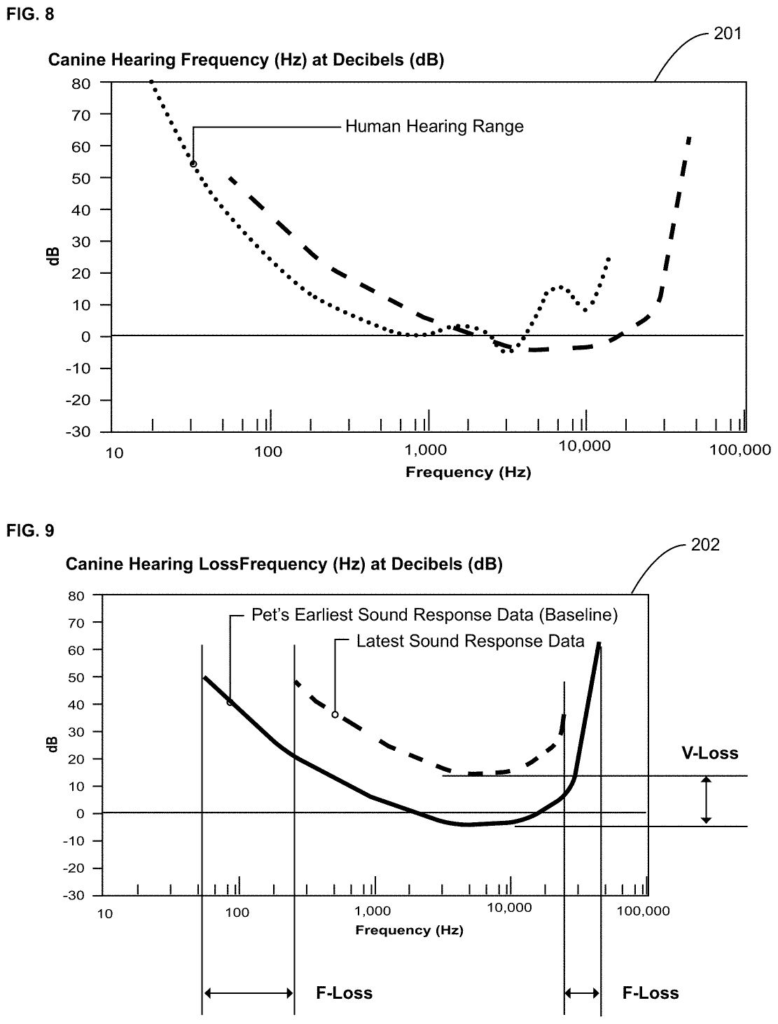

FIG. 8 is an exemplary illustration of a graph showing a typical dog's hearing range. Unlike humans, dogs are not subjected to routine hearing tests. However, dogs do suffer hearing loss. Hearing acuity for dogs varies considerably based on age, breed and other factors. However, the normal hearing range of a dog will generally follow the pattern shown in the canine hearing range graph 201.

One embodiment of the method of cycling through a plurality of sounds at varying amplitude and frequencies while monitoring a motion sensing dog collar for movement that correlated directly to the playing of various sounds is the recording of the dog's movements throughout the spectrum of sounds played by the sound device. The correlation of movement data, even nuanced movements, to the occurrence of a given sound can be charted on a graph to illustrate the dog's response to frequency and amplitude changes throughout the normally accepted range of hearing. Such a graph provides a visual indication of the dog's unique hearing acuity and hearing range.

As can be seen in the graph 201, dogs may typically hear sounds at the lowest and highest frequencies of their hearing range only if the amplitude, or volume is high. However, dogs will hear sounds in mid frequency range at a much lower volume. Dogs cannot typically hear sounds at a frequency lower than 65 Hz, or higher than 60 kHz.

For comparison purposes, the typical human hearing response at various frequencies and amplitudes is shown as a dotted line. As will be appreciated, it would be preferable that the first sounds that are presented to a dog for purposes of behavior modification are at frequencies and amplitudes that are outside of the typical human range, since the playing of such sounds within human hearing range would be disruptive and annoying to humans if the sounds are played within the dog's house while the house while humans are present.

FIG. 9 is an exemplary illustration of a graph showing a given dog's loss of hearing by comparing an historical behavioral response to frequencies and amplitudes to a current behavioral response to frequencies and amplitudes.

More specifically, a dog's response to changes in sound can be identified by tracking changes in movement. A dog hearing test provides an approximation of the dog's current hearing acuity. Unless tests are repeated over a period of time, changes in the dog's response to the same test sounds cannot be determined. Therefore, one method of determining a dog's hearing loss is to establish a baseline hearing response, shown as the solid graph line in the hearing loss graph 202, and compare that baseline sound response to the response to the same sounds by conducting the same test a subsequent time in the future, and comparing the response data.

In the graph 202, a Latest Sound Response line is shown as a dashed line. As will be immediately evident, the Latest Sound Response graph line compared to the Baseline solid graph line shows that the dog as lost hearing acuity at the opposite ends of the frequency range, the loss being shown as “F5 Loss”. Further, the dashed line is positioned higher on the Y axis indicating that while the dog does indeed respond to certain mid-range frequencies, that these frequencies are only perceived when they are played at a higher volume.

In one embodiment, the animal behavior management system includes a connecting device adapted to be attached to an animal (e.g. a collar that goes around the neck of the animal, a body harness, a device capable of attaching to a body part of the animal). In one embodiment, the animal behavior management system further includes a monitoring device (e.g. motion sensor, microphone) configured to monitor an action of the animal (e.g. body movement, sound). The monitoring device is preferably attached to the connecting device but may be remote of the connecting device. In one embodiment, the animal behavior management system further includes a control unit (e.g. computer, server computer, cloud computer, mobile device) in communication with the monitoring device that is configured to determine if the action of the animal is related to an undesirable behavior (e.g. physical movement of the animal associated with undesirable behavior, movement of the head or neck of the animal associated with undesirable behavior, scratching excessively, barking) of the animal. In one embodiment, the animal behavior management system further includes a sound device (e.g. speaker) in communication with the control unit that is adapted to emit a plurality of sounds (e.g. undesirable sounds) that are audible to the animal. The sound device may be attached to the connecting device or not attached to the connecting device. In one embodiment, the control unit activates the sound device to produce one of the plurality of sounds when the action is determined by the control unit to be an undesirable behavior.

In one embodiment, the control unit is configured to determine if the action related to the undesirable behavior has stopped within a period of time after a first sound of the plurality of sounds has been emitted by the sound device. In one embodiment, the control unit is configured to determine at least one effective sound of the plurality of sounds that is effective at stopping the undesirable behavior. In one embodiment, the control unit is configured to determine at least one ineffective sound of the plurality of sounds that is ineffective at stopping the undesirable behavior. In one embodiment, the at least one effective sound and the at least one ineffective sound are stored within a database. In one embodiment, the control unit does not activate the sound device to produce the at least one ineffective sound. In one embodiment, the control unit activates the sound device to produce the at least one ineffective sound. In one embodiment, the plurality of sounds each have a different frequency. In one embodiment, the control unit compares a current reaction time of the animal to a past reaction time during producing of one of the plurality of sounds, wherein if the current reaction time is greater than the past reaction time more than a threshold time amount the control unit sends a notification that the animal has a loss of hearing.

Computer analysis of baseline data and latest sound response data can identify differences that correlate to hearing loss, and the resulting data may be presented to the pet owner or veterinarian by means of a software application on a smartphone, of by a text or email message to the dog's owner or veterinarian.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the animal behavior management system is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the animal behavior management system will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the animal behavior management system, suitable methods and materials are described above. Thus, the animal behavior management system is not intended to be limited to the embodiments shown, but is to be accorded the widest scope consistent with the principles and features disclosed herein.

What is claimed is:

1. An animal behavior management system, comprising:
a connecting device adapted to be attached to an animal;
a monitoring device configured to monitor an action of the animal, wherein the monitoring device is attached to the connecting device;
a control unit in communication with the monitoring device, wherein the control unit is configured to determine if the action of the animal is related to an undesirable behavior of the animal, and wherein the control unit is remotely located with respect to the monitoring device; and
a sound device in communication with the control unit, wherein the sound device is adapted to emit a plurality of sounds that are audible to the animal, wherein the control unit activates the sound device to produce at least one of the plurality of sounds when the action is determined by the control unit to be an undesirable behavior.

2. The animal behavior management system of claim 1, wherein the connecting device is comprised of a collar.

3. The animal behavior management system of claim 1, wherein the monitoring device is comprised of a motion sensor.

4. The animal behavior management system of claim 1, wherein the monitoring device is comprised of a microphone.

5. The animal behavior management system of claim 1, wherein the sound device is comprised of a speaker.

6. The animal behavior management system of claim 1, wherein the sound device is not attached to the connecting device.

7. The animal behavior management system of claim 1, wherein the control unit is comprised of a server computer or mobile device.

8. The animal behavior management system of claim 1, wherein the action is comprised of a physical movement of the animal.

9. The animal behavior management system of claim 1, wherein the action is comprised of a physical movement of a head or neck of the animal.

10. The animal behavior management system of claim 1, wherein the action is comprised of an animal sound produced by the animal.

11. The animal behavior management system of claim 1, wherein the action is comprised of a physical movement by the animal and an animal sound produced by the animal.

12. The animal behavior management system of claim 1, wherein the sound is comprised of an undesirable sound to the animal that produces a physical response by the animal.

13. The animal behavior management system of claim 1, wherein the control unit is configured to determine if the action related to the undesirable behavior has stopped within a period of time after a first sound of the plurality of sounds has been emitted by the sound device.

14. The animal behavior management system of claim 13, wherein the control unit is configured to determine at least one effective sound of the plurality of sounds that is effective at stopping the undesirable behavior.

15. The animal behavior management system of claim 14, wherein the control unit is configured to determine at least one ineffective sound of the plurality of sounds that is ineffective at stopping the undesirable behavior.

16. The animal behavior management system of claim 15, wherein the at least one effective sound and the at least one ineffective sound are stored within a database associated with the animal.

17. The animal behavior management system of claim 16, wherein the control unit does not activate the sound device to produce the at least one ineffective sound.

18. The animal behavior management system of claim 16, wherein the control unit activates the sound device to produce the at least one ineffective sound.

19. The animal behavior management system of claim 1, wherein the plurality of sounds each have a different frequency.

20. The animal behavior management system of claim 1, wherein the control unit compares a current reaction time of the animal to a past reaction time during producing of one of the plurality of sounds, wherein if the current reaction time is greater than the past reaction time more than a threshold time amount the control unit sends a notification that the animal has a loss of hearing.
